(19) United States
(12) Patent Application Publication
(10) Pub. No.: US 2024/0123704 A1
(43) Pub. Date: Apr. 18, 2024

(54) BIO-SUSTAINABLE NONWOVEN FABRICS AND METHODS FOR MAKING SAID FABRICS

(71) Applicant: LYNAM PHARMA LIMITED, Aylesbury, Buckinghamshire (GB)

(72) Inventors: Shailesh PATEL, Aylesbury (GB); Hamidreza AROUNI, Aylesbury (GB); Vera CHETTY, Aylesbury (GB); Katarzyna KOWAL, Aylesbury (GB)

(21) Appl. No.: 18/277,922

(22) PCT Filed: Feb. 2, 2022
(86) PCT No.: PCT/IB2022/050892

§ 371 Date: Aug. 18, 2023

(30) Foreign Application Priority Data
Feb. 18, 2021 (GB) 2102275.1
Aug. 17, 2021 (GB) 2111791.6

(51) Int. Cl. B32B 5/26; A41D 13/12; B32B 5/02; B32B 27/12; B32B 27/36; B32B 37/20; B32B 38/08; D04H 1/413; D04H 1/4258; D04H 1/435; D04H 1/4374; D04H 1/587; D04H 1/64; D04H 1/724; D04H 3/013; D04H 3/037; D04H 3/16

(52) U.S. Cl. CPC B32B 5/269; A41D 13/1236; B32B 5/022; B32B 27/12; B32B 27/36; B32B 37/20; B32B 38/08; D04H 1/413; D04H 1/4258; D04H 1/435; D04H 1/4374; D04H 1/587; D04H 1/64; D04H 1/724; D04H 3/013; D04H 3/037; D04H 3/16; A41D 2500/30; B32B 2250/20; B32B 2250/40; B32B 2260/023; B32B 2260/046; B32B 2262/0276; B32B 2264/102; B32B 2305/28; B32B 2307/54; B32B 2307/7163; B32B 2307/718; B32B 2307/724; B32B 2367/00; B32B 2535/00; D10B 2401/12; D10B 2401/13; D10B 2509/00

(57) ABSTRACT

A sustainable nonwoven fabric having at least one spunbond layer 30 comprising biodegradable polymer fibres of polylactic acid or a derivative thereof and a biodegradable binder and optionally including an antimicrobial agent within the binder. One or more additional layers (30, 32) of blended plant-derived fibres and/or biodegradable polymer fibres are included in the fabric which are laminated together.

The present invention relates to novel bio-sustainable nonwoven fabrics, to methods for making such fabrics and to their applications, in particular in relation to the protective garments.

### BACKGROUND

Nonwoven fabrics are used in a variety of industries such as healthcare, aerospace, automotive and sports. The nonwoven fabrics are commonly produced using several synthetic fibres derived from petrochemical based substances. (e.g., Polypropylene, polyester, polyamide and polyethylene), man-made plant-derived fibres such as viscose, modal or plant and animal based natural fibres (cotton, abaca, hemp, wool). Different nonwoven fibre structures, bonding and layering technologies are used to give the desired thermal, chemical and mechanical properties for the fabric to meet the required need.

In a healthcare setting, nonwoven fabrics are used in several single use medical items, such as surgical gowns, drapes and disposable patient sheets, and are designed to be discarded after single use. The most common form of gown is made from a polypropylene trilaminate spunbond-meltblown-spunbond nonwoven fabric, known as SMS. The SMS fabric comprises a top and bottom layer of polypropylene spunbond fabric and a middle layer of polypropylene meltblown fabric. This combination is used to provide strength and durability combined with wicking and barrier properties, with the polypropylene spunbond fabric providing the strength and durability and the small polypropylene fibres of meltblown fabric providing a barrier to fluids and particles.

An inherent problem of nonwoven fabric of this type is that once the fabric becomes wet due to prolonged contact with blood or other fluid, it no longer provides an effective barrier to microorganisms. Such fabrics may also be uncomfortable to wear for long periods of time.

Bacterial or virus adhesion to nonwoven fabric poses a considerable threat to healthcare staff as contaminants on the surface can be inadvertently transferred to the personnel. Bacteria and viruses, such as the coronaviruses (SARS/MERS/COVID-19) can survive on dry surfaces for days or weeks depending on the environment.

Furthermore, products made from petrochemical based fibres (such as polypropylene commonly used in production of the SMS nonwoven fabric) are considered single use plastics. These are currently treated through either incineration or reprocessed and sent to landfill.

The need to develop sustainable fabrics which can be disposed of in a manner that has minimal environmental impact is becoming more prevalent. The nonwoven fabric must be able to separate effectively during the reprocessing stage, so that the constituent parts can be sorted and reused.

Attempts have been made to provide biodegradable and/or antimicrobial fabrics, such as in CN101675829 (A), WO2006100665 (A2), WO2016125132 (A1), CN106948088 (A), US2018022879 (A1), EP3067445 (A1), US2013190408 (A1) CN105077764 (A) and EP 3227490 (A1). However, there remains a need for a nonwoven fabric that has improved barrier properties, enhanced comfort and may have its constituent parts sorted and reused, thereby providing a bio-sustainable fabric. The present invention aims to address this need.

### SUMMARY OF THE INVENTION

According to a first aspect of the present invention there is provided a nonwoven fabric comprising:
at least one spunbond layer comprising biodegradable polymer fibres of polylactic acid or a derivative thereof; and
at least one biodegradable and/or biobased binder applied to at least one layer of the fabric.

Preferably, the binder is applied to an intended outer surface of the fabric.

Additional layers of blended plant-derived fibres and/or biodegradable polymer fibres may be included in the fabric. Preferably, all the biodegradable polymer fibres are biobased fibres, especially being polylactic acid (PLA) or a derivative thereof.

At least one additional layer may comprise a carded hydroentangled and/or thermally bonded nonwoven made up from plant-derived fibres and/or a biodegradable, optionally biobased polymer fibres. Preferably, the plant-derived fibres are cellulosic fibres which are selected from the group consisting of LENZING™ Lyocell Fibres, Veocel™ fibres and viscose fibres. Alternatively or additionally, at least one barrier layer may be provided composed of a wetlaid cellulose-based fibrils, optionally blended with wood pulp fibres, biodegradable polymer fibres and/or plant-derived fibres. Alternatively or additionally, a PLA meltblown layer, an additional PLA spunbond layer or a permeable PLA film may be included in the multiple layer nonwoven fabric. =

In a preferred aspect of the invention, there is provided a non-woven fabric comprising:
at least two layers of biodegradable polymer fibres thermally or chemically bonded together; and
at least one biodegradable binder applied to at least one layer of the fabric, more preferably being applied to an intended outer surface of the fabric.

Preferably, the nonwoven fabric consists essentially of biodegradable or biobased ingredients, most preferably being selected from PLA, coPLA and/or PBAT (polybutyrate adipate terephthalate) and a biobased or biodegradable binder.

The second layer may comprise a carded nonwoven mix of Veocel™ and polylactic acid fibres, especially bicomponent PLA. In another embodiment, the second layer comprises a carded nonwoven mix of Veocel™ and viscose fibres or Veocel™, PLA and viscose fibres, or Veocel™, PLA bicomponent, and viscose fibres, or Veocel™ PLA, and PLA bicomponent, or viscose, PLA, and PLA bicomponent. The nonwoven may be hydroentangled, chemically bonded, ultrasonically bonded, flat thermally bonded, thermally embossed or thermally point bonded. The at least one biodegradable binder is preferably selected from a polyester elastomer, biobased polyester, PLA, starch-based binders, a biobased binder based on modified biopolymers and natural plant compounds, such as Organoclick Tex304™ binder and a urethane binder. Preferably, the binder is a biobased binder based on modified biopolymers and natural plant compounds, such as Organoclick Tex304™ binder or urethane binder. More preferably, the biobased binder may comprise n-octyltriethoxysilane and zirconium acetate such as OrganoClick Tex304 manufactured by Organoclick. This is a waterproof binder that is biodegradable and fluorocarbon free.

Optionally but preferably, an antimicrobial agent may be provided onto the binder or within the binder wherein the binder acts as a carrier for the agent. The antimicrobial agent is preferably selected from chitosan or metal oxide nanoparticles, preferably zinc, silver or copper oxide nanoparticles. The incorporation of the antimicrobial agent into the binder limits the agent to one surface of the fabric only. Other additives may be included with the binder, such as pigments.

In a preferred embodiment of the invention, a second layer comprises a PLA meltblown layer. Preferably, the binder is applied onto at least the intended outer layer of the fabric.

Alternatively, the second layer may be provided by laminating a film of biobased or biodegradable polymer, such as PLA, coPLA or PBAT to the first spunbond layer.

The polylactic acid filaments that provide the layers may be provided in different configurations. For example, bicomponent continuous filaments that consist of more than one polymer type or the same polymer with different cross-linking groups may be arranged in different configurations within the filament cross-section, such as a core-sheath arrangement, side-by-side or segmented pie arrangement.

More preferably still, the fabric comprises a trilaminate composite structure having a second layer of wetlaid LENZING™ Lyocell Fibrils which can be blended with wood pulp and/or PLA or PLA biocomponent fibres, a PLA meltblown layer or a biodegradable polymer laminated film layer and a third layer comprising another PLA spunbond layer. Preferably, PLA spunbond layer forms the outer layer with the binder applied onto this layer. Alternatively, a binder may be provided throughout the layers, for example being a biobased binder, such as a n-octyltriethoxysilane and zirconium acetate sold under the trade name OrganoClick Tex304. Again, optionally, an antimicrobial agent may be provided on or within the binder formulation such that this is located in at least the outer layer(s) of the fabric.

In a further embodiment of a tri-layer fabric according to the invention, the fabric comprises a second layer of a permeable biodegradable polymeric film or membrane, preferably a PLA breathable film, and a third layer of PLA spunbond having binder applied to this layer. In this embodiment, it is possible to include less binder due to the barrier being provided by the breathable film. The binder may also be provided in an outer layer with the antimicrobial agent.

More preferably, the nonwoven fabric comprises at least three laminated layers comprising at least two spunbond layers comprising biodegradable polymer fibres of polylactic acid or a derivative thereof and at least one middle layer of meltblown polylactic acid or a derivative thereof sandwiched between the spunbond layers; at least one biodegradable and/or biobased binder applied to an intended outer surface of the fabric; and an antimicrobial agent selected from chitosan and metal oxide nanoparticles, the antimicrobial agent being provided within the biodegradable and/or biobased binder.

A second aspect of the present invention provides a method for manufacturing a nonwoven fabric according to the first aspect of the present invention, the method comprising the steps of:
forming a spunbond layer of biodegradable polymer fibres of polylactic acid or a derivative thereof;
separately forming at least one other layer comprising at least one type of plant-derived fibre and/or biodegradable polymer fibres;
assembling the layers together to form a laminate by thermal or chemical bonding;
applying a biodegradable binder to at least one layer of the fabric, preferably onto an intended outer surface of the laminated fabric; and
drying the fabric.

The at least one other layer of nonwoven fabric may be assembled from a mix of plant-derived fibres and/or biobased biodegradable polymer fibres, comprising at least two different types of fibres forming a carded layer bonded by hydroentanglement, chemical, or thermal bonding.

The at least two different types of plant-derived fibre for the other layer are cellulosic fibres and/or polylactic acid fibres. More preferably, the cellulosic fibres are selected from the group consisting of LENZING™ Lyocell fibres, Veocel™ fibres, viscose fibres and wood pulp fibres. More preferably, the fibre mix is a blend of Veocel™ fibres with PLA fibres or PLA biocomponent fibres. Preferably, the mixture of different plant-derived fibres and/or PLA are provided in a 5:95 to 95:5 ratio, more preferably 60:40-40:60 mix, especially a 50:50 mix.

Preferably, the fibres making up the other layer are bonded via hydroentanglement at a suitable pressure, such as hydroentangled at a pressure of 15-100 bar (1500000-10000000 Pa), preferably 20-50 bar (2000000-5000000 Pa), especially 20 bar (2000000 Pa) or by thermal bonding, preferably flat thermal bonding, more preferably by point bonding at the temperature>120° C., and 1 ton pressure, or by ultrasonic bonding or by chemical bonding.

The binder may be applied to at least one layer, preferably the outer surface layer by any suitable means, such as by spraying, coating or impregnation, more preferably being applied by spraying. Preferably, the binder is sprayed onto an outer surface of the fabric at a pressure of 0.1-10.0 bar (10000-1000000 Pa), preferably 0.5-2 bar (50000-200000 Pa), especially 0.7 bar (70000 Pa). It is preferable for the binder to be applied at a solid content concentration of 5-30 wt. %, more preferably 20 wt. %, especially 10 wt. %. Preferably, spraying of the binder onto the outer surface of the fabric provides 5-20 g·m² binder add-on level, more preferably 5-15 gm².

An antimicrobial agent may be incorporated into the binder prior to its application to the fabric or applied onto the already sprayed binder by spraying or powder scattering or powder coating methods. Preferably, the antimicrobial agent is selected from chitosan or metal oxide nanoparticles, preferably zinc, silver or copper oxide nanoparticles. More preferably, the antimicrobial agent is a metal oxide nanoparticles incorporated onto the binder layer at a concentration of 0.5-15% add-on, more preferably 0.5-10%, more preferably 0.5-6%, especially 0.5-3% add-on.

Preferably, drying of the fabric is carried out at a temperature of at least 80° C., more preferably 105° C. for at least 2 minutes, more preferably at 140° C. for 3 minutes.

In one embodiment, the other layer is provided by blending the bicomponent PLA fibres with PLA and Veocel™ and/or viscose fibres, carded and thermally bonded at the temperature>120° C., preferably >130° C. The binder is sprayed onto one side of this fabric.

In a further embodiment, the method includes applying at least one additional layer to provide at least a trilayer nonwoven fabric. In another embodiment of a nonwoven fabric according to the invention, a blended layer of carded, point bonded nonwoven comprising biocomponent PLA fibres, Veocel™ and/or viscose fibres is laminated onto the PLA spunbound layer and a layer comprising wetlaid fibrillated lyocell fibres (LENZING™ Lyocell fibrils) and optionally blended with wood pulp. A hydrophobic additive or treatment was added to the slurry, at a ratio of 4:1 to 6:1, more preferably 5:1 additive solid content to fibre weight. The wetlaid layer is dried, preferably at a temperature of at least 149° C. for at least 5 minutes prior to lamination. with the carded layer.

Optionally, the method may include lamination using a thermal method, with or without an adhesive layer, depending upon the fibre composition. The adhesive layer can include thermoplastic powder. The binder is applied on either the wetlaid or the PLA spunbond, depending on which one is laminated to the carded layer.

The LENZING™ Lyocell Fibrils is wetlaid on its own or with addition of the wood pulp and/or PLA fibres or PLA bicomponent fibres at 95:5 to 5:95 ratio, preferably at 50:50. Preferably, the weight of the wetlaid fabric is 3-60 gm², more preferably 5-30 gm⁻², more preferably 10-25 gm⁻². A hydrophobic additive or treatment may be added to the slurry, at a ratio of 4:1 to 6:1, more preferably 5:1 additive solid content to fibre weight. The wetlaid layer is dried, preferably at a temperature of at least 80° C. prior to lamination with the carded layer.

More preferably, the blended carded layer is laminated onto a wetlaid fibrillated lyocell fibres (LENZING™ Lyocell Fibrils) optionally mixed with wood pulp to form the second layer and these two layers are laminated with the PLA spunbound layer. Lamination may be carried out via thermal methods with the inclusion of an adhesive layer. The adhesive layer can include thermoplastic powder. Preferably, the binder is sprayed onto the PLA spunbound layer.

A preferred method according to the invention comprises forming a first spunbond layer of biodegradable polymer fibres of polylactic acid or a derivative thereof, separately forming a meltblown layer of biodegradable polymer fibres of polylactic acid or a derivative thereof, assembling the layers together to form a laminate by thermal or chemical bonding;
applying a biodegradable binder to at least one layer of the laminated fabric; and
drying the fabric.

More preferably, a third spunbond PLA layer is formed and bonded to the meltblown layer.

In an alternative embodiment, the method comprises forming a first spunbond layer of biodegradable polymer fibres of polylactic acid or a derivative thereof; separately forming a film of biodegradable polymer fibres of polylactic acid or a derivative thereof; assembling the layers together to form a laminate by thermal or chemical bonding; applying a biodegradable binder to at least one layer of the laminated fabric; and drying the fabric.

More preferably, a third spunbond PLA layer is formed and bonded to the PLA film.

The binder may be applied to one or more layers, more preferably being applied to an intended outer layer of the fabric. An antimicrobial agent may be incorporated into the binder prior to its application to the fabric or applied onto the already sprayed binder by spraying or powder scattering or powder coating methods.

In a preferred embodiment, the method comprises the steps of: forming separate spunbond layers of biodegradable polymer fibres of polylactic acid or a derivative thereof; separately forming at least one other layer comprising a meltblown layer of biodegradable polymer fibres of polylactic acid or a derivative thereof; assembling the layers together to form a laminate by thermal or chemical bonding; applying a biodegradable binder incorporating an antimicrobial agent selected from chitosan and metal oxide nanoparticles onto an intended outer surface of the laminated fabric; and drying the fabric.

A third aspect of the present invention provides a bio-sustainable article formed from a nonwoven fabric according to the first aspect of the present invention. The article may comprise a surgical article such as a surgical gown, a surgical drape or disposable bed sheets. Preferably, the article consists essentially of biodegradable or biobased ingredients, most preferably being selected from PLA, coPLA and/or PBAT (polybutyrate adipate terephthalate) and a biobased or biodegradable binder.

### Definitions

“Carding” in the context of this disclosure describes a mechanical process of separating individual fibres using a series of dividing and redividing steps, that causes many of the fibres to align in parallel to one another while also removing dust and impurities. Random fibre orientation can also be achieved using a specific carding machine. The layers of the carded fibres can be arranged into a parallel-laid or cross-laid layers to provide the required mechanical and physical properties of the consolidated nonwoven in machine and cross machine directions.

“Hydroentanglement” or “spunlace” in the context of this disclosure relates to a bonding process for wet or dry fibrous webs made by either carding, airlaying or wetlaying, the resulting bonded fabric being a nonwoven. Generally fine, high pressure jets of water are used to penetrate the web, hit a conveyor belt or wire and bounce back causing the fibres to entangle, thereby providing fabric integrity.

“Thermal bonding” uses heat to melt thermoplastic powders or fibres to form thermal bonded nonwovens fabrics. Bonding can be accomplished at high speed with heated calendar rolls or ovens. There are numerous techniques available for carrying out thermal bonding, including through-air bonding, ultra-violet bonding, infra-red bonding, flat calender and point bonding calender bonding.

“Spunbound” relates to nonwoven fabrics that are made by extruding continuous filaments onto a moving belt. The filaments are spun and then directly dispersed into a web by deflectors or air streams, using any one of a number of spinning techniques but melt spinning is most widely used. The extruded filaments are solidified and drawn from the spinneret and deposited onto a conveyor belt, followed by web consolidation, whereby strength is provided to the web through mechanical, chemical or thermal bonding methods.

“Meltblown” refers to a fabric wherein a polymer melt is extruded through small nozzles surrounded by high speed blowing gas to form ultrafine filaments at the diameters<100 μm. The randomly deposited filaments form a nonwoven sheet product.

“Bio-sustainable” means using natural resources responsibly so that they will be available for many generations. A bio-sustainable future requires consideration of meeting today's needs and protecting the environment and resources, by the use of biodegradable or recyclable materials to reduce waste and limit use of resources.

### BRIEF DESCRIPTION OF THE DRAWINGS

For a better understanding of the present invention and to show more clearly how it may be carried into effect, reference will now be made by way of example only, to the accompanying drawings and following examples, in which:

FIG. 1 is a schematic diagram of a single layer nonwoven fabric according to one embodiment of the present invention;

FIG. 2 is a schematic diagram of a double layer nonwoven fabric according to a second embodiment of the present invention;

FIG. 3 is a schematic diagram of an alternative double layer nonwoven fabric according to another embodiment of the present invention;

FIG. 4 is a schematic diagram of a triple layer nonwoven fabric according to yet a further embodiment of the present invention;

FIG. 5 is a schematic diagram of a trilaminate nonwoven fabric according to an embodiment of the present invention;

FIG. 6 illustrates the steps in processing the nonwoven fabric shown in FIG. 5;

FIG. 7 is a schematic diagram of a trilaminate nonwoven fabric according to still a further embodiment of the present invention;

FIG. 8 illustrates the steps in processing the nonwoven fabric shown in FIG. 7;

FIG. 9A is a front view of a surgical gown formed of nonwoven fabric according to the present invention, shown in an open state; and

FIG. 9B is a rear view of the surgical gown shown in FIG. 5B, shown in a fastened state.

### DETAILED DESCRIPTION OF THE INVENTION

The present invention relates to a novel nonwoven fabric that is particularly suitable for single-use, protective garments, such as surgical gowns and drapes. The fabric is made from bio-sustainable and/or biodegradable components and may also provide the additional benefits of providing an improved barrier to fluids and microorganisms and enhanced comfort to the wearer.

In some embodiments, the nonwoven fabric is provided from at least one layer of a carded and hydroentangled and/or thermally bonded, blend of at least two plant-derived fibres, such as the cellulosic Lyocell fibres, Veocel™ and/or viscose and/or biodegradable polymer fibres such as polylactic acid (PLA) fibres. PLA is an environmentally friendly, plant-derived thermoplastic. In other embodiments, the nonwoven fabric is provided exclusively by layers of the biodegradable polymers PLA, PBAT or their derivatives laminated together, preferably having at least one layer of spunbond PLA or a PLA derivative. The fabric is also provided with a biobased and/or biodegradable binder such as a urethane, polyester elastomer, biobased polyester, PLA and starch based binders and optionally includes an antimicrobial agent within the binder, for example plant-derived Chitosan or a metal oxide nanoparticles. One or more additional biodegradable layers may be included in the fabric, such as a layer of wetlaid wood pulp with other cellulosic fibres, a layer of PLA spunbond or PLA meltblown or a biodegradable film.

Some embodiments of the fabric structure are predominantly made using wetlaid or carding to deliver the required fabric attributes. This is in contrast to conventional surgical garment fabrics which use a Polypropylene spunbond-meltblown-spunbond fabric, with the meltblown fabric providing a barrier layer.

Thus, the present invention provides a nonwoven fabric construction made substantially of bio-sustainable and biodegradable fibres (e.g. cellulose derived and polylactic acid). A hydrophobic additive may be used to provide hydrophobicity to the wetlaid layer and therefore increase the barrier properties. The biodegradable binder provides hydrophobicity to the outer surface as well as acting as a carrier for the metal oxide nanoparticles or chitosan which may be applied to the outer surface of the fabric providing additional anti-microbial activity without penetrating all the way through the fabric, thereby reducing any contact with the wearer and his microorganism flora. The biopolymer fibres make the nonwoven fabric fully biobased and biodegradable. The metal oxide nanoparticles provide anti-microbial activity. The nonwoven fabric has a high tensile strength, low linting, lightweight and is fluid resistant.

One embodiment of a nonwoven fabric 1 according to the present invention is illustrated in FIG. 1. A single nonwoven web layer 2 was assembled by carding a fibre blend composed of Veocel™, a man-made cellulose based fibre and bicomponent polylactic acid PLA (bicoPLA) fibres. PLA is a biodegradable thermoplastic aliphatic polyester derived from renewable biomass, typically from fermented plant starch such as from corn, cassava, sugarcane or sugar beet pulp. The Veocel™ and PLA fibres are blended in 50:50 ratio, being consolidated via hydroentanglement (2×50 bar or 5000000 Pa) and/or thermal bonding at minimum 120° C. A biodegradable binder 4 (represented by dots in FIG. 1) consisting of urethane binder (such as SciTec ST6515), together with metal oxide nanoparticles (optional), were incorporated by spraying onto the outer surface at 0.7 bar (70000 Pa) and 20 wt. % solid content concentration to achieve a 15% binder and nanoparticles at 6% add-on level. The fabric was then dried at 105° C. for 5 minutes.

The single layer nonwoven fabric may be used to provide a protective article, such as a surgical gown. The fabric provides an effective barrier to fluids and microorganisms while being relatively soft and permeable providing comfort to the wearer. The fabric is also bio-sustainable, being produced by plant based fibres that may be broken down to constituent components and re-used.

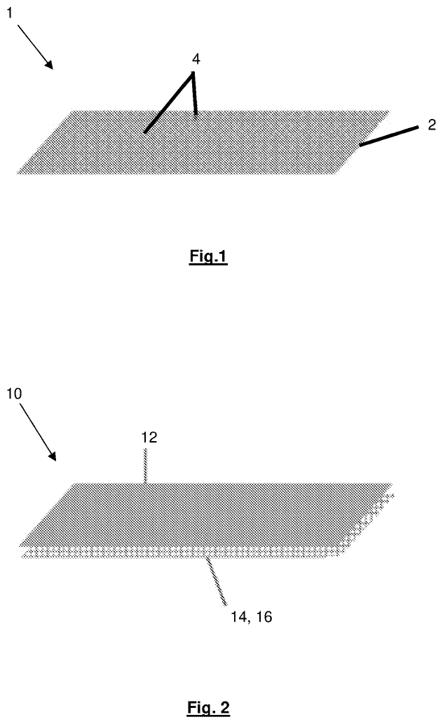

FIG. 2 of the accompanying drawings illustrates an alternative nonwoven fabric 10 according to the present invention. This embodiment is made up of two layers, a first layer 12 consisting of a blend of two types of plant-derived fibres, namely Veocel™ and viscose fibres. Viscose fibres are also derived from wood or bamboo pulp. The second layer 16 consists of spunbound polylactic acid (PLA) having a binder 14 and, optionally, metal oxide nanoparticles sprayed onto an outer surface of the PLA.

The nonwoven web at 20 gm⁻² was assembled by carding the fibre blend containing Veocel™ and viscose fibres in a 50:50 ratio. The carded web was then assembled with the 20 gm⁻² polylactic acid spunbound fabric using hydroentanglement at 50 bar nonwoven pressure and/or thermal bonding at minimum 120° C. The binder 14, comprising SciTec ST6515 biodegradable urethane binder was sprayed onto the outer surface of the PLA spunbound to achieve 15% binder level, followed by incorporation of the metal oxide nanoparticles, such as silver or copper, at a concentration of 6% w/w via spraying. The binder was sprayed at 0.7 bar (70000 Pa) pressure and 21 wt. % solid content concentration. The fabric was dried at 105° C. for 5 minutes.

This provided a bio-sustainable nonwoven fabric that has a softer protective layer 12 that may be worn comfortably next to the skin with a barrier layer 16 that prevents fluid penetrating through to the softer layer and also provides some antibacterial activity.

FIG. 3 of the accompanying drawings illustrates an alternative embodiment of a two-layer nonwoven fabric 20 according to the present invention. This embodiment contains no PLA but has two cellulose-based nonwoven layers 22, 28 with the composite layer being provided with the binder 24 and, optionally, metal oxide nanoparticles.

The first layer 22 was a carded nonwoven web at 20 gm² assembled from fibres containing Tencel® and viscose fibres in a ratio of 50:50. The first layer web was hydroentangled at 20 bar (200000 Pa) pressure or thermally bonded to provide a low level of entanglement and dimensional stability. The second layer 28 consisted of fibrillated cellulosic Lyocell wetlaid together with wood pulp fibres, where the Lyocell content was 22% and the wood pulp content was 78%. A hydrophobic additive (NeverWet) or other suitable treatment was added to the slurry, at a ratio of 4:1 to 6:1, more preferably 5:1 additive solid content to fibre weight. The fabric areal density was 32 gm². The second fibre web was dried at 100° C. for 5 minutes to achieve hydrogen bonding and then the wet laid 28 and carded layers 22 were assembled by hydroentanglement at 50 bar (5000000 Pa) pressure.

It is to be appreciated that the first layer and/or second layer may comprise other plant derived fibre compositions. For example, the second layer may be 100% fibrillated lyocell with 15 g/m² areal density.

The binder 24, consisting of SciTec ST6515 biodegradable urethane binder 20 wt. % solid content concentration, was sprayed on to the wetlaid side 28 of the composite substrate to achieve a maximum of 5 gm⁻² binder add-on optionally with metal oxide nanoparticles incorporated at 6% w/w by spraying. The binder and antimicrobial agent were sprayed at 0.7 bar (70000 Pa) pressure. The fabric was dried at 105° C. for 5 minutes.

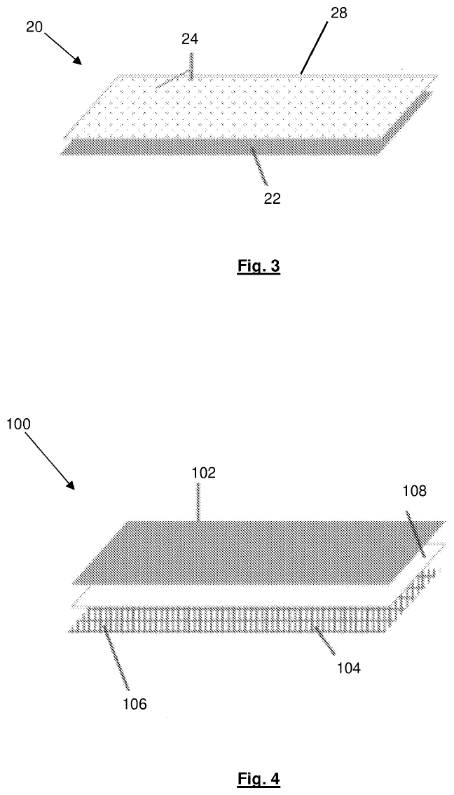

A further embodiment of a bio-sustainable nonwoven fabric material 100 is illustrated in FIG. 4. This embodiment is a tri-layer arrangement more akin to conventional spunbound melt blown spunbound SMS fabric derived from petrochemical based substances that is conventionally used for disposable protective garments. However, this fabric is softer, bio-sustainable and provides enhanced protection against wetting and microorganisms. The fabric 100 is composed of two fibre layers 102, 108 with a PLA spunbond layer 106 including the binder 104.

The first fibre layer 102 was a nonwoven fabric at 20 gm⁻² containing Tencel® and bicomponent PLA fibres in a ratio of 50:50. The second layer 108 consisted of 100% Lenzing fibrillated. The second fibre web was dried at 100° C. for 5 minutes to achieve hydrogen bonding and then these two layers were laminated with 20 gm⁻² polylactic acid (PLA) spunbound fabric via hydroentanglement at 50 bar (5000000 Pa) pressure.

The binder 104, consisting of SciTec ST6515 biodegradable urethane binder 20 wt. % solid content concentration, was sprayed on to the wet laid side 106 of the composite substrate to achieve a maximum of 5 gm⁻² binder add-on optionally with metal oxide nanoparticles were incorporated at 6% w/w by spraying. The binder and antimicrobial agent were sprayed at 0.7 bar (70000 Pa) pressure. The fabric was dried at 100° C. for 3 minutes.

Other preferred embodiments of the invention have at least one spunbond PLA or PLA derivative layer laminated to a PLA meltblown layer or a PLA film with a further spunbond layer, as described in more detail below. The layers are formed separately and joined together by thermal, chemical or ultrasonic bonding. The binder may be applied to one, two or all layers depending upon the level of hydrophobocity required. Antimicrobial agent is preferably applied to the intended outer side of the fabric.

The Examples below provide further details of web formation, web bonding, composition and treatment for a number of embodiments of nonwoven fabrics according to the invention.

### Example 1: Single Layer Nonwoven Fabric

Web Formation: Carding
Web Bonding: Hydroentanglement; chemical bonding; thermal bonding (through air, flat calendaring, point bond calendaring), ultrasonic bonding.
   Total 20-100 g·m⁻², preferably 30-60 g·m⁻²; especially 40-50 g·m⁻².
Composition: Veocel™ and viscose fibres, or Veocel™, PLA and viscose fibres, or Veocel™, PLA bicomponent, and viscose fibres, or Veocel™, PLA, and PLA bicomponent, or viscose, PLA, and PLA bicomponent fibres.
   The blend preferably comprises one type of plant-derived fibres blended with PLA fibres in a ratio 5:95 to 95:5, more preferably 50:50.
   The PLA fibres can be also a blend of PLA and PLA bicomponent fibres with ratio 5:95 to 95:5, more preferably 50:50.
Treatment: Binder/additive applied (spraying, impregnation, coating).
   The binder add on levels are from 1-50%, preferably 10-20% add on.
   The antimicrobial agent is applied at 1-15% add on, more preferably 1-6%.

### Example 2: Double Layer Nonwoven Fabric

A single layer as described in Example 1 above was prepared but without the binder/additive applied to it. A second layer was then applied to this layer as detailed below:
Web Forming/bonding: Spunbond PLA layer, PLA/PLA layer or PLA/coPLA layer. Preferably 15-60 g·m⁻², especially 15-30 g·m⁻²
Treatment: Binder/additive applied (spraying, impregnation, coating) The binder add on levels are from 1-50%, preferably 2-7% add on. Optional anti-microbial agent is applied at 1-15% add on, more preferably 1-6%.

In the illustrated examples, reference to PLA/PLA layer, PLA/coPLA and/or PLA/PBAT layers refer to different configurations of the biodegradable polymer fibres within a filament cross-section for preparation of the spunbond layer or polymer film. For example, bicomponent continuous filaments that consist of more than one polymer type or the same polymer with different cross-linking groups may be arranged in different configurations within the filament cross-section, such as a core-sheath arrangement, side-by-side or segmented pie arrangement.

### Example 3: Double Layer Nonwoven Fabric

A single layer as described in Example 1 above was prepared but without the binder/additive applied to it. A second layer was then applied to this layer as detailed below:
Web Formation: Wetlaid.
Web Bonding: Hydrogen, chemically or thermally bonded.
Total: 3-60 g·m⁻², preferably 5-30 g·m⁻², especially 10-25 g·m⁻²
Composition: LENZING™ Lyocell Fibrils, which can be blended with wood pulp and/or PLA or PLA bicomponent fibres.
   The blend preferably contains 100% fibrils, however, can be blended with wood pulp and/or 95:5 to 5:95 ratio, and more preferably 50:50.
Treatment: Hydrophobic binder/additive applied (spraying, impregnation, coating). The binder add on levels are from 1-50%, preferably 2-7% add on. The antimicrobial agent is applied at 1-15% add on, more preferably 1-6%.

### Example 4: Double Layer Nonwoven Fabric

A nonwoven double layer fabric was made from the following layers:

Layer 1:
Web Formation: Wetlaid.
Web Bonding: Hydrogen, chemically or thermally bonded.
   Total: 3-60 g·m⁻², preferably 5-30 gm⁻², especially 10-25 g·m⁻²
Composition: LENZING™ Lyocell Fibrils, which can be blended with wood pulp and/or PLA or PLA bicomponent fibres.
   The blend preferably contains 100% fibrils, however, can be blended with wood pulp and/or 95:5 to 5:95 ratio, and more preferably 50:50.
Treatment: Hydrophobic binder/additive optionally applied (spraying, impregnation, coating).

Layer 2:
Web Forming/bonding: Spunbond PLA layer, PLA/PLA layer or PLA/coPLA layer. Preferably 15-60 g·m⁻², especially 15-30 g·m⁻².
Treatment: Binder/additive applied (spraying, impregnation, coating) The binder add on levels are from 1-50%, preferably 2-7% add on. The anti-microbial agent is applied at 1-15% add on, more preferably 1-6%.

### Example 5: Double Layer Nonwoven Fabric

A single layer as described in Example 1 above was prepared but without the binder/additive applied to it then a second layer as applied to it as detailed below:
Web bonding: Permeable PLA film, PLA/PLA film or PLA/coPLA film.
   Preferably 5-30 g·m⁻², most preferably 15-25 g·m⁻².
Treatment: Binder/additive applied (spraying, impregnation, coating) The binder add on levels are from 1-50%, preferably 2-7% add on. Optional anti-microbial agent is applied at 1-15% add on, preferably 1-6%.

### Example 6: Triple Layer Nonwoven Fabric

A single layer as described in Example 1 above was prepared but without the binder/additive applied to it. A second and third layer were then applied to it as detailed below:

Layer 2:
Web Formation: Wetlaid.
Web Bonding: Hydrogen, chemically or thermally bonded.
   Total: 3-60 g·m⁻², preferably 5-30 g·m⁻², especially 10-25 g·m⁻².
Composition: LENZING™ Lyocell Fibrils, which can be blended with wood pulp and/or PLA or PLA bicomponent fibres.
   The blend preferably contains 100% fibrils, however, can be blended with wood pulp and/or 95:5 to 5:95 ratio, and more preferably 50:50.
Treatment: Hydrophobic binder/additive applied (spraying, impregnation, coating). The binder add on levels are from 1-50%, preferably 2-7% add on. The antimicrobial agent is applied at 1-15% add on, more preferably 1-6%.

Layer 3:
Web Forming/bonding: Spunbond PLA layer, PLA/PLA layer or PLA/coPLA layer. Preferably 15-60 g·m⁻², especially 15-30 g·m⁻²
Treatment: Binder/additive applied (spraying, impregnation, coating) The binder add on levels are from 1-50%, preferably 2-7% add on. The anti-microbial agent is applied at 1-15% add on, more preferably 1-6%.

### Example 7: Triple Layer Nonwoven Fabric

Layer 1:
Web Bonding: Spunbond PLA layer, PLA/PLA layer or PLA/coPLA layer.
   Preferably 10-60 g·m⁻², especially 10-30 g·m⁻²
Treatment: None applied.

Layer 2:
Web Formation: Wetlaid.
Web Bonding: Hydrogen, chemically or thermally bonded.
   Total: 3-60 g·m⁻², preferably 5-30 g·m⁻², especially 10-25 g·m⁻²
Composition: LENZING™ Lyocell Fibrils, which can be blended with wood pulp and/or PLA or PLA bicomponent fibres.
   The blend preferably contains 100% fibrils, however, can be blended with wood pulp and/or 95:5 to 5:95 ratio, and more preferably 50:50.

Treatment: None applied.

Layer 3:
Web Bonding: Spunbond PLA layer, PLA/PLA layer or PLA/coPLA layer.
   Preferably 10-60 g·m⁻², especially 10-30 gm⁻².
Treatment: Binder/additive applied (spraying, impregnation, coating) The binder add on levels are from 1-50%, preferably 2-7% add on. The anti-microbial agent is applied at 1-15% add on, more preferably 1-6%.

### Example 8: Triple Layer Nonwoven Fabric

A single layer as described in Example 1 above was prepared but without the binder/additive applied to it. A second and third layer were then applied to it as detailed below:

Layer 2:
Film: Permeable PLA film, coPLA film or PLA plus PBAT (polybutyrate adipate terephthalate) film
   Preferably 5-30 g·m⁻², most preferably 15-25 g·m⁻².
Treatment: None applied.

Layer 3:
Web Forming/bonding: Spunbond PLA layer, PLA/PLA layer of PLA/coPLA layer. Preferably 10-60 g·m², especially 10-30 g·m².
Treatment: Binder/additive applied (spraying, impregnation, coating) The binder add on levels are from 1-50%, preferably 2-7% add on. The anti-microbial agent is applied at 1-15% add on, more preferably 1-6%.

### Example 9: Triple Layer Nonwoven Fabric

Layer 1:
Web Forming/bonding: Spunbond PLA layer. Preferably 15-60 g·m⁻², especially 15-30 g·m⁻²
Treatment: None applied.

Layer 2:
Film: Permeable PLA film.
   Preferably 15-25 g·m⁻², most preferably 8-22 g·m⁻²
Treatment: None applied.

Layer 3:
Web Bonding: Spunbond PLA layer. Preferably 15-60 g·m⁻², especially 15-30
Treatment: Binder/additive applied (spraying, impregnation, coating) The binder add on levels are from 1-50%, preferably 2-7% add on. The anti-microbial agent is applied at 1-15% add on, more preferably 1-6%.

### Example 10: Triple Layer Nonwoven Fabric

A single layer as described in Example 1 above was prepared but without the binder/additive applied to it. Second and third layers were then applied to it as detailed below:

Layer 2:
Web Bonding: Meltblown PLA layer. Preferably 3-60 g·m⁻², especially 3-15 g·m⁻².
Treatment: None applied.

Layer 3:
Web Bonding: Spunbond PLA layer, PLA/PLA layer or PLA-coPLA layer.
   Preferably 15-60 g·m⁻², especially 15-30 g·m⁻²
Treatment: Binder/additive applied (spraying, impregnation, coating) The binder add on levels are from 1-50%, preferably 5-30% add on. The anti-microbial agent is applied at 1-15% add on, more preferably 1-6%.

### Example 11: Triple Layer Nonwoven Fabric

Layer 1:
Web Bonding: Spunbond PLA layer. Preferably 15-60 g·m⁻², especially 15-30 g·m⁻²
Treatment: None applied.

Layer 2:
Web Bonding: Meltblown PLA layer. Preferably 3-60 g·m⁻², especially 3-15 g·m⁻².
Treatment: None applied.

Layer 3:
Web Bonding: Spunbond PLA layer. Preferably 15-60 g·m⁻², especially 15-30 g·m⁻².
Treatment: Binder/additive applied (spraying, impregnation, coating) The binder add on levels are from 1-50%, preferably 2-7% add on. The anti-microbial agent is applied at 1-15% add on, more preferably 1-6%.

### Example 12: Trilaminate Nonwoven Fabric

Layer 1:
Web Bonding: Spunbond PLA, PLA/PLA or PLA/coPLA layer. Preferably 10-30 g·m⁻², especially 15-20 g·m⁻².

Layer 2:
Web Bonding: Meltblown PLA layer. Preferably 5-40 g·m⁻², especially 15-30 gm⁻².

Layer 3:
Web Bonding: Spunbond PLA, PLA/PLA or PLA/coPLA layer. Preferably 10-30 g·m⁻², especially 15-20 g·m⁻²
Treatment: The three layers are assembled into the trilaminate by thermal bonding using point and/or flat calendaring or are ultrasonically bonded. Binder/water repellant coating is applied via spraying, impregnation or coating. The binder add on levels are from 1-50%, preferably 5-30% add on. The anti-microbial agent is applied at 0.5-15% add on, more preferably 0.5-3% with or without additional binder at <5% add on.

### Example 13: Trilaminate Nonwoven Fabric

Layer 1:
Web Bonding: Spunbond PLA, PLA/PLA or PLA/coPLA layer. Preferably 10-30 g·m⁻², especially 10-20 g·m⁻².

Layer 2:
Web Bonding: PLA, coPLA or PLA-PBAT film layer. Preferably 10-100 g·m⁻², especially 15-60 g·m².

Layer 3:
Web Bonding: Spunbond PLA, PLA/PLA or PLA/coPLA layer. Preferably 10-30 g·m⁻², especially 10-20 g·m⁻².
Treatment: The three layers are assembled into the trilaminate by thermal bonding using point and/or flat calendaring or are ultrasonically bonded. The anti-microbial agent is applied at 0.5-15% add on, more preferably 0.5-3% with or without additional binder at <5% add on.

It is to be appreciated that the preferred embodiments of the present invention are those that are predominantly comprised of a PLA material. Polylactic acid is an inherently wettable polymer with a surface energy of 42 mNm⁻¹, compared with the polypropylene filaments conventionally used in SMS nonwoven fabric products. Such high wettability of the PLA means that any fabric would have poor liquid barrier performance, making the use of such a biodegradable polymer for fabrics used in surgical gowns problematic. However, the nonwoven composite structures of the present invention have overcome this problem to provide laminated structures that are substantially wholly biodegradable or recyclable while also providing the required barrier properties and optionally, enhanced antimicrobial activity.

In essence, the preferred embodiments of the invention provide a recyclable PLA fabric provided with barrier properties through its structure combined with a hydrophobic coating and enriched with antimicrobial activity provided by nanomaterials.

### Example 14: Manufacture of a Spunbond Meltblown Spunbond (SMS) Trilaminate Structure According to a Preferred Embodiment of the Present Invention and Investigations into the Properties of the Fabric

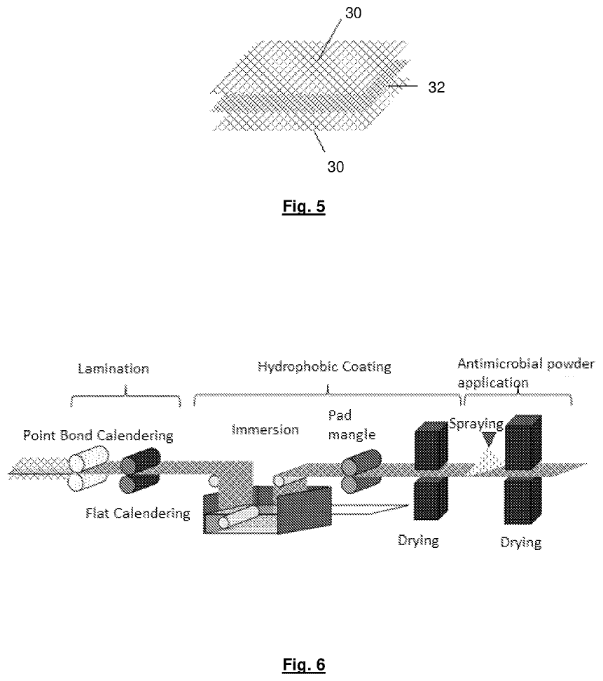

A trilaminate composite fabric structure was prepared with a middle layer of meltblown PLA nonwoven (20 g·m⁻¹) 32 sandwiched between two PLA spunbond nonwovens 30 (each being 18 g·m⁻²), as illustrated in FIG. 5 of the accompanying drawings.

One example of the assembly route for the nonwoven fabric shown in FIG. 5 is illustrated in FIG. 6 of the accompanying drawings. The separate spunbond and meltblown layers 30, 32 are laminated together using point bond and flat calendaring before application of a hydrophobic coating, such as OrganoClick Tex304™ by immersion in the coating, followed by squeezing through a pad mangle and drying. An antimicrobial powder application is then applied to an outer surface of the fabric by spraying and then dried.

The present invention provides a composite assembly route where the spunbond and meltblown fabrics can be produced separately, rather than in one line as is conventional the case with other SMS nonwoven fabrics, and then joined using thermal bonding, chemical bonding, or ultrasonic bonding. This method provides the alternative option to hydrophobically treating the entire composite as the hydrophobic treatment can be applied to one, two or all three layers separately prior to bonding.

The liquid penetration of the structure where only the middle meltblown layer was treated prior to lamination provides the liquid penetration value at 31.5±1.2 mm H2O, as detailed in Table 1 below.

The presence of antimicrobial agent on the outer side of the fabric provides the biocidal activity against the microorganisms, and hence reduces the risk of contamination as well as contributes to breaking the transmission of the nosocomial infections.

The enhanced hydrophobicity of the PLA fabric is achieved by merging the structural properties of the porous nonwoven composite with the chemistry of the surface treatments based on n-octyltriethoxysilane and zirconium acetate chemistry such as OrganoClick Tex304. The structure provides the mechanical and barrier properties required for a surgical gown, with the liquid penetration 35.58±1.72 cm H2O, as demonstrated in Table 1 below.

TABLE 1

| | | | | Hydrophobic | Antimicrobial | Binder to |
|---|---|---|---|---|---|---|
| | | Areal | | Binder | agent | antimicrobial |
| | | density | Assembly | application | application | powder solid |
| Layer | Composition | g · m⁻² | method | method | method | ratio |
| Spunbond | PLA | 2×18 | Point bond | Impregnation | Spray | 1:0.2 |
| Meltblown | PLA | 1×20 | and flat | | | |
| | | | bond | | | |
| | | | calendering | | | |
| | | | | | Target acc. to | |
| Property | | Unit | Value | StDev | ISO EN 13795 | Test method |
| Total areal density | | g · m⁻² | 64.95 | 2.13 | NA | ISO 9073-1, |
| | | | | | | NWSP |
| | | | | | | 130.1.R0 (15) |
| Hydrophobic binder add-on | | % | 17.0 | 0.5 | NA | NA |
| Antimicrobial powders + | | % | 3.0 | 0.3 | NA | NA |
| binder mix add-on | | | | | | |
| Thickness | | mm | 0.269 | 0.024 | NA | NWSP |
| | | | | | | 120.1.R0 (15) |
| Air permeability | | 1 · m⁻¹ · s⁻¹ | 63.10 | 5.37 | NA | EN ISO 9073- |
| at 100 Pa pressure drop | | | | | | 15, NWSP |
| | | | | | | 070.1.R0 (15) |
| Pore size | Largest | um | 18.75 | 1.61 | NA | NA |
| | Mean flow | | 6.49 | 0.90 | NA | |
| | Smallest | | 2.36 | 0.20 | NA | |
| Tensile | MD | N | 69.32 | 6.48 | ≥20 | ISO 9073- |
| strength | | | | | | 18:2007, BS |
| Dry | | | | | | EN 29073-3, |
| | | | | | | NWSP |
| | | | | | | 110.1.R0 (15) |
| | CD | | 40.78 | 2.30 | ≥20 | ISO 9073- |
| | | | | | | 18:2007, BS |
| | | | | | | EN 29073-3, |
| | | | | | | NWSP |
| | | | | | | 110.1.R0 (15) |
| Tensile | MD | N | 69.02 | 5.81 | ≥20 | ISO 9073- |
| strength | | | | | | 18:2007, BS |
| Wet | | | | | | EN 29073-3, |
| | | | | | | NWSP |
| | | | | | | 110.1.R0 (15) |
| | CD | | 38.68 | 3.18 | ≥20 | ISO 9073- |
| | | | | | | 18:2007, BS |
| | | | | | | EN 29073-3, |
| | | | | | | NWSP |
| | | | | | | 110.1.R0 (15) |
| Burst strength Dry | | kPa | 42.06 | 1.95 | ≥40 | EN ISO |
| | | | | | | 13938-1 |
| Burst strength Wet | | kPa | 41.00 | 0.78 | ≥40 | EN ISO |
| | | | | | | 13938-1 |
| Liquid penetration | | cm H₂O | 35.58 | 1.72 | ≥30 | BS EN ISO |
| | | | | | | 811:2018 |

### Example 15: Manufacture of a Spunbond Film Spunbond (SFS) Trilaminate Structure According to a Preferred Embodiment of the Present Invention and Investigations into the Properties of the Fabric

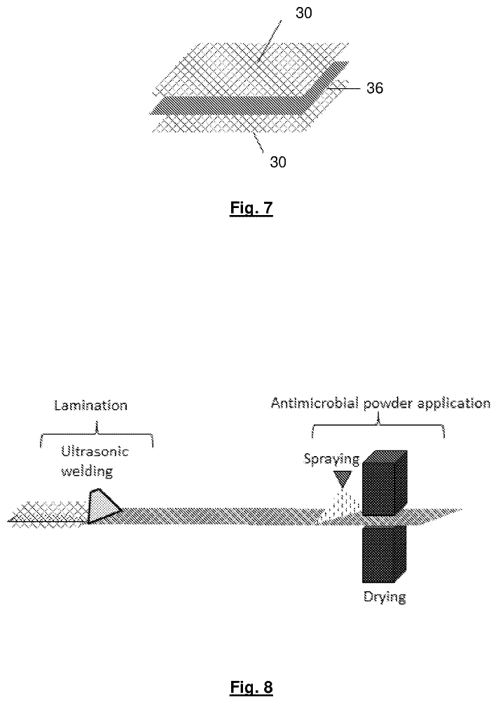

A trilaminate composite fabric structure was prepared with two outer PLA spunbond nonwoven fabrics 30 and an inside layer of PLA porous film 36, as shown in FIG. 7 of the accompanying drawings. The laminate was assembled by thermal or ultrasonic bonding and one side of the laminate was treated with a biobased hydrophobic binder known as OrganoClick Tex304™ manufactured by OrganoClick AB of Sweden and antimicrobial agents to provide a biocidal effect. FIG. 8 of the accompanying drawings illustrates the assembly route for this nonwoven fabric.

Table 2 below provides testing results for this structure, illustrating its mechanical and barrier properties.

TABLE 2

| | | | | | Binder | |
|---|---|---|---|---|---|---|
| | | | | | to | |
| | | | | | antimi- | Antimi- |
| | | | | | crobial | crobial |
| | | | Areal | | powder | agent |
| | | Compo- | density | Assembly | solid | application |
| Layer | | sition | g · m⁻² | method | ratio | method |
| Film | | PLA | 50 | Ultrasonic | 1:0.2 | Spraying |
| Spunbond | | PLA | 20 | point | | |
| | | | | bonding | | |
| | | | | | Target | |
| | | | | | acc. to | |
| | | | | | ISO | |
| | | | | | EN | Test |
| Property | | Unit | Value | StDev | 13795 | method |
| Total | | g · m⁻² | 93.02 | 1.53 | NA | ISO |
| areal | | | | | | 9073-1, |
| density | | | | | | NWSP |
| | | | | | | 130.1.R0 |
| | | | | | | (15) |
| Anti- | | % | 3.0 | 0.3 | NA | NA |
| microbial | | | | | | |
| powders + | | | | | | |
| Organo- | | | | | | |
| Click | | | | | | |
| Tex304 | | | | | | |
| binder | | | | | | |
| mix | | | | | | |
| add-on | | | | | | |
| Thickness | | mm | 0.865 | 0.156 | NA | NWSP |
| | | | | | | 120.1.R0 |
| | | | | | | (15) |
| Tensile | MD | N | 80.18 | 6.58 | ≥20 | ISO 9073- |
| strength | | | | | | 18:2007, |
| | | | | | | BS EN |
| | | | | | | 29073-3, |
| | | | | | | NWSP |
| | | | | | | 110.1.R0 |
| | | | | | | (15) |
| Dry | CD | | 51.42 | 4.27 | ≥20 | ISO 9073- |
| | | | | | | 18:2007, |
| | | | | | | BS EN |
| | | | | | | 29073-3, |
| | | | | | | NWSP |
| | | | | | | 110.1.R0 |
| | | | | | | (15) |
| Tensile | MD | N | 67.76 | 2.49 | ≥20 | ISO 9073- |
| strength | | | | | | 18:2007, |
| Wet | | | | | | BS EN |
| | | | | | | 29073-3, |
| | | | | | | NWSP |
| | | | | | | 110.1.R0 |
| | | | | | | (15) |
| | CD | | 53.36 | 2.23 | ≥20 | ISO 9073- |
| | | | | | | 18:2007, |
| | | | | | | BS EN |
| | | | | | | 29073-3, |
| | | | | | | NWSP |
| | | | | | | 110.1.R0 |
| | | | | | | (15) |

| | | | | | |
|---|---|---|---|---|---|
| Burst | kPa | 149.74 | 3.58 | ≥40 | EN ISO |
| strength | | | | | 13938-1 |
| Dry | | | | | |
| Burst | kPa | 145.06 | 2.89 | ≥40 | EN ISO |
| strength | | | | | 13938-1 |
| Wet | | | | | |
| Liquid | cm H₂O | 68.85 | 9.35 | ≥30 | BS EN ISO |
| penetration | | | | | 811:2018 |

The results show that the trilaminate composite structure provides mechanical and barrier properties on the levels required by gown performance standards, with liquid penetration at 68.85±9.35 cm H2O.

The presence of antimicrobial agent on the outer side of the fabric provides the biocidal activity against microorganisms and hence, reduces the risk of contamination as well as contributing to the breakage of transmission of nosocomial infections. The nonwoven fabric according to the present invention has many properties that make it particularly suitable for use in the production of protective garments, such as surgical gowns and drapes. The fabric has high tensile strength, softness, comfort, breathability, wearability, and is also lightweight. Typical commercially available gowns have a skin layer made of petrochemical based spunbond fabric. The present fabric benefits from nonwoven cellulosic fibres or PLA fibres on one surface of the fabric which may form an inner skin-contacting surface of a garment which has improved softness and tactile comfort.

The treated outer layer or middle film acts as a water-repellent and as a barrier against bacteria, blood and other liquids. The present invention uses a process of incorporating the antimicrobial product into a biodegradable binder, such as a urethane binder or another biobased binder such as treatments based on n-octyltriethoxysilane and zirconium acetate chemistry such as OrganoClick Tex304. The surface application of the binder with the antimicrobial product on to the fabric surface prevents the metal oxide nanoparticles/chitosan from being in contact with the user and provides maximum opportunity to be in contact with surface microorganisms which come in contact with the fabric.

Furthermore, the plant-derived or biobased fibres used in its production enable the constituent parts to be recovered and recycled or biodegraded, for example by mechanical recycling, organic recycling and energy recovery. This represents a significant environmental advancement given the vast quantities of protective surgical gear that are disposed of worldwide on a daily basis. In this respect, single use personal protective equipment, although still infectious, is classified as orange bag waste and therefore does not have to be incinerated. Recycling of the constituent parts will enable a reduction in carbon emission in relation to this type of equipment.

The fabric of the present invention has been used to produce a surgical gown which is 100% recyclable, including the cuffs and fasteners of the gown. Example 16 below discusses one embodiment of a surgical gown according to this aspect of the invention.

### Example 16: Surgical Gown Made with a Nonwoven Fabric According to the Invention

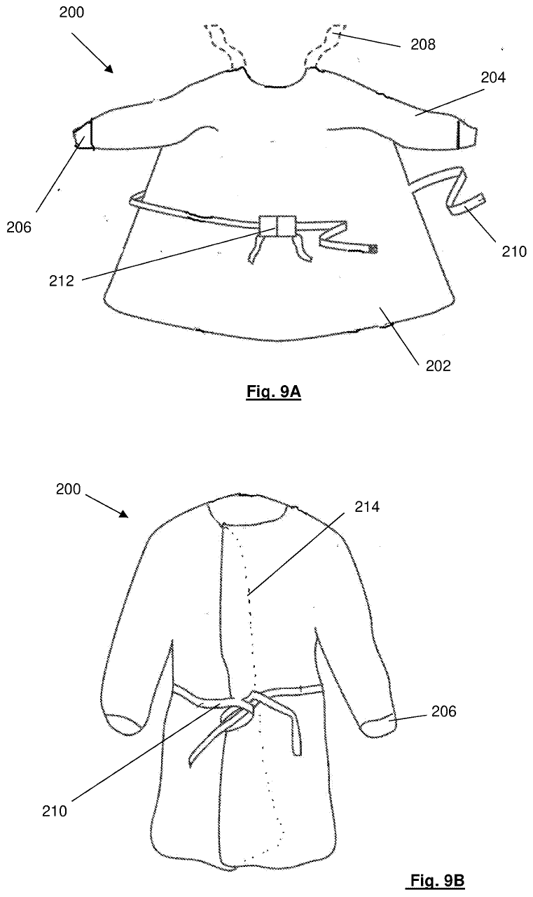

FIGS. 9A and 9B illustrate a fully biodegradable surgical gown 200 according to the present invention. The main body 202 and sleeves 204 of the gown are made from the nonwoven fabric material of Example 15. The arms of the gown are provided with cuffs 206 manufactured from PLA-textured yarn Type 5PVM dtex to produce tubular ringspun cuffs of 40 mm diameter. These are seamless and latex free. The gown is also provided with neck ties 208 and waist ties 210 which are also made from the nonwoven fabric of the invention. These may be made out of the off cuts from the main gown fabric 202. Additionally, a tie holder 212 is provided at the front of the gown to hold the ties. The holder is also made of PLA and has a slot for receiving the ties.

The gown 200 may be provided in sterile sheet (not shown) which is also made from the same material as the gown.

Thus, a surgical gown is provided in which all parts of the gown are biodegradable.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of preferred embodiments. Thus the scope of the embodiments should be determined by the appended claims and their legal equivalents, rather than by the examples given.

The invention may be described by reference to the following numbered paragraphs:

1. A nonwoven fabric comprising:
at least one layer comprising plant-derived fibres and/or biodegradable polymer fibres; and
at least one biodegradable and/or biobased binder applied to at least an intended outer surface of the fabric.

2. The nonwoven fabric according to paragraph 1 wherein at least one layer comprises a carded hydroentangled and/or thermally bonded nonwoven made up from plant-derived fibres and/or a biobased or biodegradable polymer fibres with at least one barrier layer composed of a wetlaid cellulose-based fibrils, optionally blended with biodegradable polymer fibres and/or plant-derived fibres, or PLA meltblown layer, or a permeable PLA film.

3. The nonwoven fabric according to paragraph 2 further comprising one or more layers of a spunbond fabric composed of biodegradable polymer filaments.

4. The nonwoven fabric according to paragraph 1 or 2, wherein the nonwoven fabric comprises:
at least one layer of a carded hydroentangled and/or chemically, and/or thermally bonded blend of at least one type of plant-derived fibres, preferably at least two types, and/or at least one type of biodegradable polymer fibre; and
at least one biodegradable binder applied to at least an intended outer surface of the fabric.

5. The nonwoven fabric according to any one of paragraphs 1 to 4 wherein the plant-derived fibres are cellulosic fibres which are selected from the group consisting of LENZING™ Lyocell Fibfres, Veocel™ fibres, viscose fibres and wood pulp.

6. The nonwoven fabric according to any one of the preceding paragraphs wherein the biodegradable polymer fibres are polylactic acid fibres.

7. The nonwoven fabric according to paragraphs 4, 5 or 6 wherein the blend comprises a carded nonwoven mix of Veocel™ and polylactic acid fibres and/or bicomponent PLA/PLA fibres.

8. The nonwoven fabric according to paragraph 4, 5 or 6 wherein the blend comprises a carded nonwoven mix of Veocel™ and viscose fibres or Veocel™, viscose fibres, and PLA, or Veocel™ and/or viscose fibres and PLA bicomponent, or Veocel™, PLA, and PLA bicomponent, or viscose, PLA, and PLA bicomponent.

9. The nonwoven fabric according to paragraph 4, 5 or 6, wherein at least one layer comprises one type of plant-derived fibres blended with PLA fibres in a ratio of 5:95 to 95:5, preferably in a ratio 40:60 to 60:40, especially 50:50.

10. The nonwoven fabric according to any one of the preceding paragraphs wherein the at least one biodegradable binder is selected from a polyester elastomer, biobased polyester, PLA, starch based binders and urethane binder, preferably being a urethane binder.

11. The nonwoven fabric according to any one of the preceding paragraphs wherein an antimicrobial agent is provided in the binder wherein the binder acts as a carrier for the agent, the antimicrobial agent preferably being selected from chitosan or metal oxide nanoparticles.

12. The nonwoven fabric according to any preceding paragraphs further comprising two or more layers of plant derived or biodegradable polymer fibres.

13. The nonwoven fabric according to paragraph 12 wherein a second layer is provided comprising a PLA spunbond layer, preferably wherein the binder is applied onto this layer.

14. The nonwoven fabric according to paragraph 12 wherein a second layer is provided comprising a wetlaid fibrillated lyocell fibres (LENZING™ Lyocell Fibrils) optionally blended with wood pulp and/or PLA or PLA biocomponent fibres.

15. The nonwoven fabric according to paragraph 12 wherein a second layer is provided comprising a PLA meltblown layer or a film of biobased or biodegradable polymer, preferably PLA.

16. The nonwoven fabric according to paragraph 12 wherein the fabric comprises a second layer selected from the group consisting of wetlaid LENZING™ Lyocell Fibrils, optionally blended with wood pulp and/or PLA or PLA biocomponent fibres; a PLA meltblown layer or a biodegradable polymer laminated film layer; the fabric further comprising a third layer comprising a PLA spunbond layer, preferably, wherein the PLA spunbond layer forms the outer layer with the binder applied onto this layer.

17. The nonwoven fabric according to paragraph 12 wherein the fabric comprises a second layer comprising a permeable biodegradable polymeric film, preferably a PLA breathable film, and a third layer of PLA spunbond having binder applied to this layer.

18. A method for manufacturing a nonwoven fabric according to any one of the preceding paragraphs, the method comprising the steps of:
assembling into a nonwoven blend of fibres comprising at least one type of plant-derived fibre and/or biodegradable polymer fibres, using at least one type of nonwoven technology to form at least one fabric layer;
applying a biodegradable binder onto an intended outer surface of a non-woven fabric comprising the at least one layer of plant-derived fibres and/or biodegradable polymer fibres; and
drying the fabric.

19. The method according to paragraph 18, wherein the at least one layer of nonwoven fabric is assembled by one or more of carding, wet laying, hydroentanglement, mechanical, chemical and/or thermal bonding.

20. The method of paragraph 18 or 19 further including a spunbond layer of a biobased biodegradable polymer fibres, preferably PLA.

21. The method of paragraph 18, 19 or 20 further comprising lamination of the nonwoven layers to form a multi-layer structure, optionally using adhesive.

22. The method according to any one of paragraphs 18 to 21 wherein the binder is applied to at least the outer surface layer by spraying, coating or impregnation, preferably by spraying.

23. A sustainable article formed from a nonwoven fabric according to any one of paragraphs 1 to 17, preferably wherein the article is a surgical article selected from a surgical gown, a surgical drape or disposable bed sheet.

24. A nonwoven fabric obtained or obtainable by the method of any one of paragraphs 18 to 22.

1. A nonwoven fabric comprising:
at least three laminated layers comprising at least two spunbond layers comprising biodegradable polymer fibres of polylactic acid or a derivative thereof and at least one middle layer of meltblown polylactic acid or a derivative thereof sandwiched between the spunbond layers;
at least one biodegradable and/or biobased binder applied to an intended outer surface of the fabric; and
an antimicrobial agent selected from chitosan and metal oxide nanoparticles, the antimicrobial agent being provided within the biodegradable and/or biobased binder.

2. The nonwoven fabric as claimed in claim 1 wherein at least one of an additional PLA meltblown layer, an additional PLA spunbond layer or a permeable PLA film is included in the nonwoven fabric.

3. The nonwoven fabric as claimed in claim 1 or claim 2, wherein the at least one biodegradable binder is selected from a polyester elastomer, biobased polyester, PLA, starch-based binders, a biobased binder based on modified biopolymers and natural plant compounds, such as a n-octyltriethoxysilane and zirconium acetate based binder and a urethane binder.

4. The non-woven fabric as claimed in claim 3, wherein the binder is selected from a biobased binder based on modified biopolymers and natural plant compounds, such as Organoclick Tex304™ binder and a urethane binder.

5. The nonwoven fabric as claimed in any one of the preceding claims, wherein the antimicrobial agent is selected from zinc, silver and copper oxide nanoparticles.

6. A method for manufacturing a nonwoven fabric, the method comprising the steps of:
forming separate spunbond layers of biodegradable polymer fibres of polylactic acid or a derivative thereof;
separately forming at least one other layer comprising a meltblown layer of biodegradable polymer fibres of polylactic acid or a derivative thereof;
assembling the layers together to form a laminate by thermal or chemical bonding;
applying a biodegradable binder incorporating an antimicrobial agent selected from chitosan and metal oxide nanoparticles onto an intended outer surface of the laminated fabric; and
drying the fabric.

7. The method according to claim 6 wherein the bonding of the layers is achieved by at least one of chemically bonding, ultrasonic bonding, flat thermal bonding, thermal embossing and thermal point bonding.

8. The method according to claim 6 or 7 wherein the binder is applied to the outer surface layer by at least one of spraying, coating and impregnation.

9. The method according to claim 8, wherein the binder is applied by spraying.

10. The method according to claim 9 wherein the binder is applied at a solid content concentration of 5-30 wt. %.

11. The method according to claim 10, wherein the binder is applied at a solid content concentration of 20 wt. %.

12. The method according to claim 10, wherein the binder is applied at a solid content concentration of 10 wt. %.

13. The method according to any one of claims 10 to 12 wherein the application of the binder onto the outer surface of the fabric provides 5-20 gm² binder add-on level.

14. The method according to claim 13, wherein the application of the binder onto the outer surface of the fabric provides 5-15 gm² binder add-on level.

15. The method according to any one of claims 7 to 14 wherein the antimicrobial agent is a metal oxide nanoparticles incorporated onto the binder layer at a concentration of 0.5-15% add-on.

16. The method according to claim 15 wherein the antimicrobial agent is a metal oxide nanoparticles incorporated onto the binder layer at a concentration of 0.5-10% add-on.

17. The method according to claim 16 wherein the antimicrobial agent is a metal oxide nanoparticles incorporated onto the binder layer at a concentration of 0.5-6% add-on.

18. The method according to claim 17, wherein the antimicrobial agent is a metal oxide nanoparticles incorporated onto the binder layer at a concentration of 0.5-3% add-on.

19. A bio-sustainable article formed from a nonwoven fabric according to any one of claims 1 to 5, preferably wherein the article is a surgical gown consisting essentially of biodegradable or biobased ingredients.
